(19) United States
(12) Patent Application Publication
(10) Pub. No.: US 2026/0126738 A1
(43) Pub. Date: May 7, 2026

(54) IMAGE FORMING APPARATUS

(71) Applicant: KYOCERA Document Solutions Inc., Osaka (JP)

(72) Inventor: Masanori Kyogoku, Osaka (JP)

(73) Assignee: KYOCERA Document Solutions Inc., (omitted)

(21) Appl. No.: 19/379,305

(22) Filed: Nov. 4, 2025

(30) Foreign Application Priority Data
Nov. 7, 2024 (JP) 2024-194862

(51) Int. Cl. G03G 15/043; G03G 15/04

(52) U.S. Cl. CPC G03G 15/043; G03G 15/04036; G03G 2215/0404

(57) ABSTRACT

An image forming apparatus includes an exposure device, a driving control unit, and an exposure control unit. The exposure device is configured to expose a photoconductor drum with light while scanning the light and thereby form an electrostatic latent image. The driving control unit is configured to generate a secondary-scanning-directional reference signal. The exposure control unit is configured to generate a secondary-scanning-directional synchronization signal in synchronization with a primary-scanning-directional reference signal correspondingly to an edge of the secondary-scanning-directional reference signal, and control the exposure device and thereby cause the exposure device to form an electrostatic latent image corresponding to an image signal in synchronization with the secondary-scanning-directional synchronization signal. Further, the driving control unit generates the secondary-scanning-directional reference signal with a waveform that includes at least one additional edge within a predetermined period from the edge.

### CROSS-REFERENCE TO RELATED APPLICATIONS

This application relates to and claims priority rights from Japanese Patent Application No. 2024-194862, filed on Nov. 7, 2024, the entire disclosures of which are hereby incorporated by reference herein.

### BACKGROUND

### 1. Field of the Present Disclosure

The present disclosure relates to an image forming apparatus.

### 2. Description of the Related Art

An electrographic image forming apparatus (a) generates a primary-scanning-directional reference signal corresponding to an exposure scanning period of a photoconductor, (b) generates a secondary-scanning-directional reference signal correspondingly to the primary-scanning-directional reference signal, and (c) determines a position of an image to be formed on the photoconductor on the basis of the secondary-scanning-directional reference signal.

FIG. 7 shows a diagram that explains generating a secondary-scanning-directional synchronization signal in synchronization with a primary-scanning-directional reference signal on the basis of a secondary-scanning-directional reference signal. In such an image forming apparatus as mentioned, an exposure control unit controls exposure of a photoconductor drum, a driving control unit generates the secondary-scanning-directional reference signal used to generate a secondary-scanning-directional synchronization signal, and if the exposure control unit and the driving control unit operate asynchronously with each other, then as shown in FIG. 7, for example, the secondary-scanning-directional reference signal VSYNCref outputted by the driving control unit is inputted to the exposure control unit, and when the exposure control unit detects an edge of the secondary-scanning-directional reference signal VSYNCref, the exposure control unit generates the secondary-scanning-directional synchronization signal in synchronization with the first primary-scanning-directional reference signal (BD signal) after the detection of the edge, and resets an edge detection status of the secondary-scanning-directional reference signal VSYNCref for next edge detection.

FIG. 8 shows a diagram that explains a case that the secondary-scanning-directional synchronization signal is not properly generated. However, the driving control unit operates asynchronously with the exposure control unit and therefore, as shown in FIG. 8, for example, when the exposure control unit resets the edge detection status in synchronization with the primary-scanning-directional reference signal (BD signal) before the edge detection of the secondary-scanning-directional reference signal VSYNCref, the edge of the secondary-scanning-directional reference signal VSYNCref may not be properly detected. Specifically, when the edge detection by the exposure control unit is repeatedly performed with a cycle TD, if the BD signal appears until the TD elapses from a timing of an edge of the secondary-scanning-directional reference signal VSYNCref, then the edge of the secondary-scanning-directional reference signal VSYNCref may not be properly detected. If the edge of the secondary-scanning-directional reference signal VSYNCref is not detected, then the secondary-scanning-directional synchronization signal VSYNC is not generated as shown in FIG. 8, for example.

### SUMMARY

An image forming apparatus according to an aspect of the present disclosure includes an exposure device, a driving control unit, and an exposure control unit. The exposure device is configured to expose a photoconductor drum with light while scanning the light and thereby form an electrostatic latent image. The driving control unit is configured to generate a secondary-scanning-directional reference signal. The exposure control unit is configured to generate a secondary-scanning-directional synchronization signal in synchronization with a primary-scanning-directional reference signal correspondingly to an edge of the secondary-scanning-directional reference signal, and control the exposure device and thereby cause the exposure device to form an electrostatic latent image corresponding to an image signal in synchronization with the secondary-scanning-directional synchronization signal. Further, the driving control unit generates the secondary-scanning-directional reference signal with a waveform that includes at least one additional edge within a predetermined period from the edge.

These and other objects, features and advantages of the present disclosure will become more apparent upon reading of the following detailed description along with the accompanied drawings.

### BRIEF DESCRIPTION OF THE DRAWINGS

FIG. 1 shows a side view that indicates an internal mechanical configuration of an image forming apparatus in an embodiment according to the present disclosure;

FIG. 2 shows a diagram that indicates an example of a configuration of an exposure device 2 shown in FIG. 1 and a peripheral configuration of the exposure device 2;

FIG. 3 shows a block diagram that indicates an electronic configuration of the image forming apparatus shown in FIGS. 1 and 2;

FIG. 4 shows a block diagram that indicates a configuration of an exposure control unit 32 shown in FIG. 3;

FIG. 5 shows a diagram that indicates an example of a secondary-scanning-directional reference signal VSYNCref and a primary-scanning-directional reference signal (BD signal);

FIG. 6 shows a timing chart that explains behaviors of a driving control unit 31 and the exposure control unit 32;

FIG. 7 shows a diagram that explains generating a secondary-scanning-directional synchronization signal in synchronization with a primary-scanning-directional reference signal on the basis of a secondary-scanning-directional reference signal; and

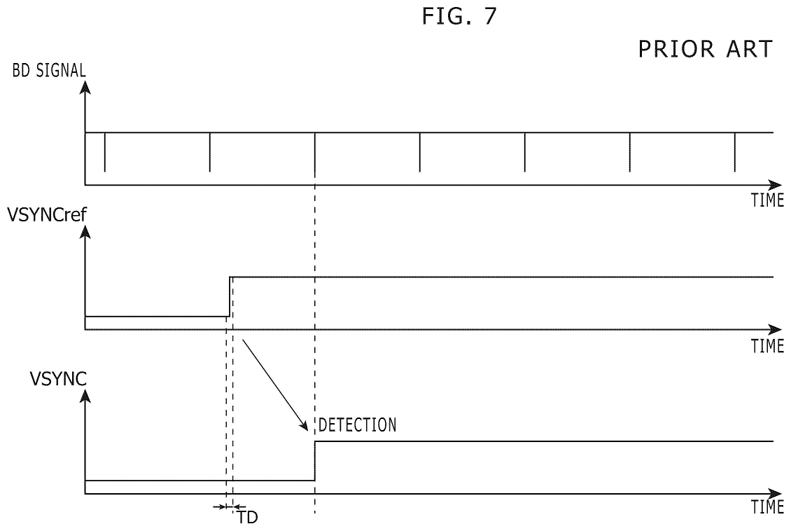

FIG. 8 shows a diagram that explains a case that the secondary-scanning-directional synchronization signal is not properly generated.

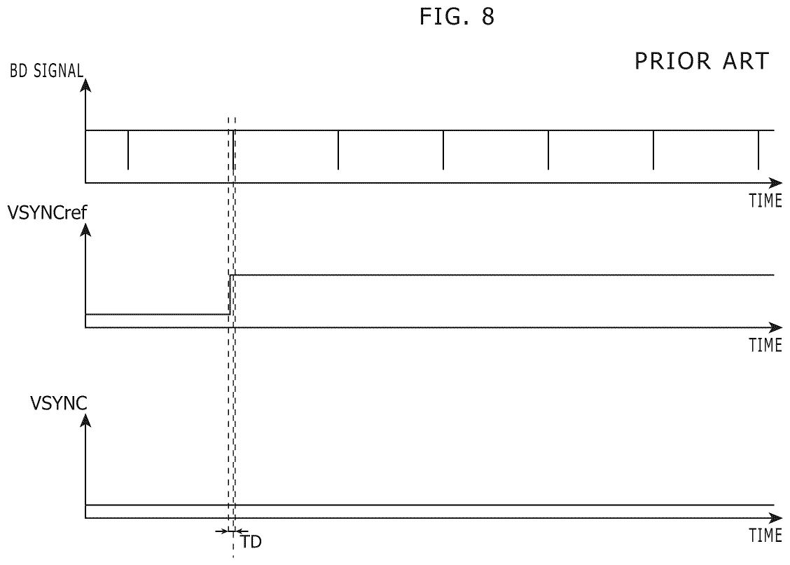

### DETAILED DESCRIPTION

Hereinafter, an embodiment according to an aspect of the present disclosure will be explained with reference to drawings.

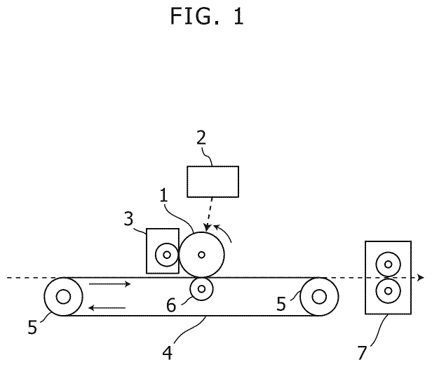

FIG. 1 shows a side view that indicates an internal mechanical configuration of an image forming apparatus in an embodiment according to the present disclosure. The image forming apparatus shown in FIG. 1 is an apparatus having an electrophotographic printing function, such as a printer, a facsimile machine, a copier or a multi function peripheral. Further, the image forming apparatus shown in FIG. 1 is a monochrome and direct-transfer image forming apparatus.

The image forming apparatus shown in FIG. 1 includes a photoconductor drum 1, an exposure device 2, a development device 3, a transportation belt 4, a driving roller 5, a transfer roller 6, and a fuser 7.

The exposure device 2 exposes the photoconductor drum 1 with light while scanning the light and thereby forms an electrostatic latent image.

A toner container including toner is mounted to the development device 3, and the development device 3 attaches the toner supplied from the toner container to the electrostatic latent image on the photoconductor drum 1.

The transportation belt 4 rotates by driving force from the driving roller 5, and thereby transports a print sheet to a position between the photoconductor drum 1 and the transfer roller 6. The transfer roller 6 makes the print sheet in transportation contact with the photoconductor drum 1, and transfers a toner image on the photoconductor drum 1 to the print sheet. The print sheet on which the toner image has been transferred is transported to the fuser 7, and the toner image is fixed on the print sheet.

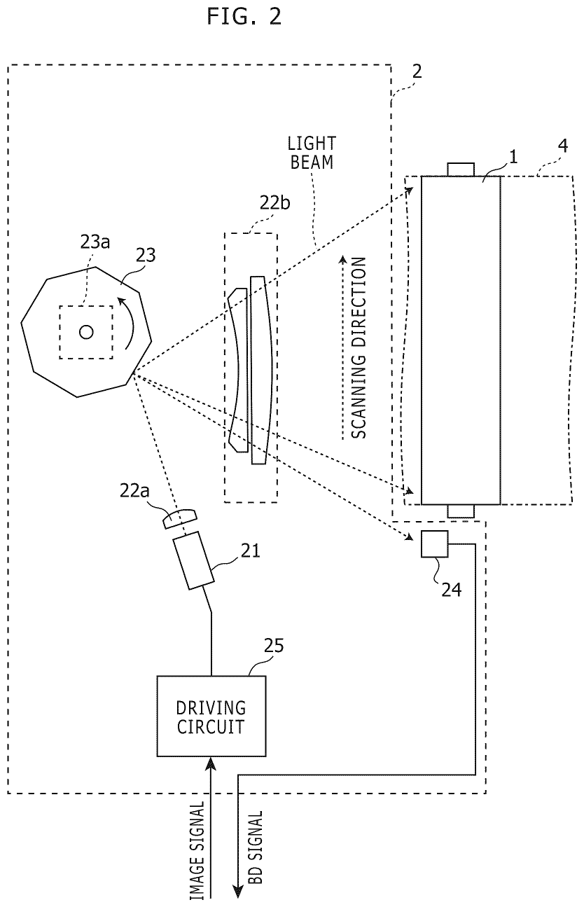

FIG. 2 shows a diagram that indicates an example of a configuration of an exposure device 2 shown in FIG. 1 and a peripheral configuration of the exposure device 2. The exposure device 2 shown in FIG. 2 includes a light source 21, a collimator lens 22a, a correction lens 22b, a polygon mirror 23, a motor 23a that rotates the polygon mirror 23, a BD sensor 24 and the like.

In FIG. 2, the light source 21 emits a laser light beam. For example, the light source 21 is a laser diode. The collimator lens 22a is a lens that coverts the laser light beam emitted from the light source 21 to a parallel light beam. The correction lens 22b is a lens that makes a movement velocity of an exposure position of the laser light beam constant.

Further, the polygon mirror 23 is an element that includes an axis perpendicular to an axis of the photoconductor drum 1, has a polygonal cross section perpendicular to the own axis, and has sides that form mirrors. The polygon mirror 23 rotates around the own axis, and scans the laser light beam emitted from the laser diode 21, along an axis direction of the photoconductor drum 1 (i.e. along a primary scanning direction).

Furthermore, the BD sensor 24 is a sensor that receives the laser light beam scanned by the polygon mirror 23 and generates a primary-scanning-directional reference signal (a signal that indicates a reference timing in the primary scanning direction). The BD sensor 24 is arranged at a predetermined position on a line on which the laser light beam is scanned, and receives the scanned laser light beam at the predetermined position and thereby generates the primary-scanning-directional reference signal (BD signal).

Here, the primary-scanning-directional reference signal takes a low level while a spot of the laser light beam passes on the BD sensor 24, and takes a high level in the other period. Therefore, the primary-scanning-directional reference signal has a cycle corresponding to a rotation speed of the polygon mirror 23, or the like.

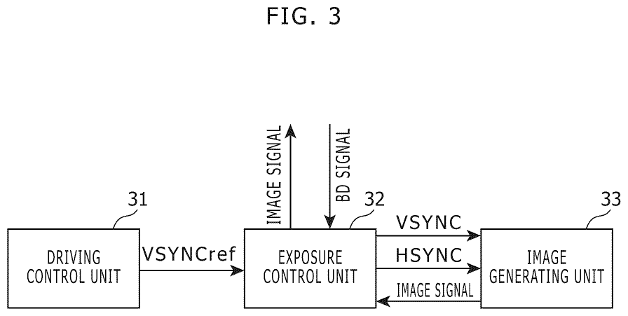

FIG. 3 shows a block diagram that indicates an electronic configuration of the image forming apparatus shown in FIGS. 1 and 2. As shown in FIG. 3, for example, this image forming apparatus includes a driving control unit 31, an exposure control unit 32, and an image generating unit 33. The driving control unit 31, the exposure control unit 32, and the image generating unit 33 are installed as individual internal devices, and operate asynchronously with each other. Each of the driving control unit 31, the exposure control unit 32, and the image generating unit 33 includes a processor (a computer including a CPU (Central Processing Unit) and the like), an ASIC (Application Specific Integrated Circuit) and/or the like, and performs predetermined control and/or a data process using the processor and/or the ASIC.

The driving control unit 31 controls the exposure control unit 32, a transportation device for a print sheet and the like, and thereby performs a print job. Further, the driving control unit 31 generates a secondary-scanning-directional reference signal VSYNCref and outputs this signal VSYNCref to the exposure control unit 32. The secondary-scanning-directional reference signal VSYNCref specifies a front-end position of a page image to be printed (i.e. depicting timing of the front end).

The exposure control unit 32 receives the BD signal from the exposure device 2 and provides an image signal to the exposure device 2 in synchronization with the BD signal. The exposure device 2 forms on the photoconductor drum 1 an electrostatic latent image corresponding to the image signal. Further, in synchronization with the BD signal, the exposure control unit 32 generates a secondary-scanning-directional synchronization signal VSYNC and a primary-scanning-directional synchronization signal HSYNC to be provided to the image generating unit 33.

Specifically, the exposure control unit 32 generates the secondary-scanning-directional synchronization signal VSYNC in synchronization with the primary-scanning-directional reference signal (i.e. BD signal) correspondingly to an edge (here, rising edge) of the secondary-scanning-directional reference signal VSYNCref, and controls the exposure device 2 and thereby causes the exposure device 2 to form an electrostatic latent image corresponding to an image signal (for one page) in synchronization with the secondary-scanning-directional synchronization signal VSYNC.

Here, the edge of the secondary-scanning-directional reference signal VSYNCref that indicates a front-end position in the secondary scanning direction (i.e. front-end timing) is a rising edge as mentioned, but alternatively, may be a falling edge.

In particular, the driving control unit 31 generates the secondary-scanning-directional reference signal VSYNCref with a waveform that includes at least one additional edge within a predetermined period from the aforementioned edge.

Here, this predetermined period is set to be shorter than time that is shorter than a cycle of the primary-scanning-directional reference signal (BD signal) by the predetermined cycle TD, and it is favorable that this predetermined period is set to be either equal to or less than a half of the cycle of the primary-scanning-directional reference signal (BD signal). Further, a time between the aforementioned edge and the additional edge is set to be longer than the aforementioned cycle TD.

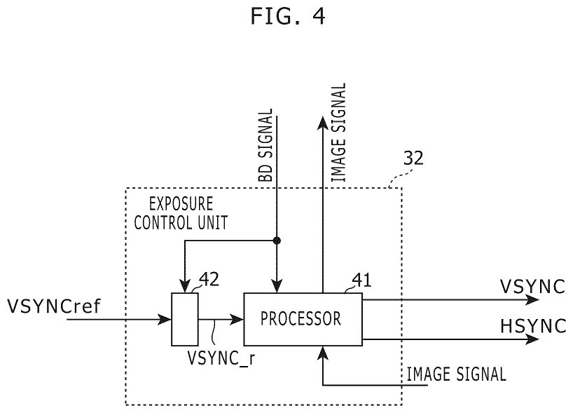

FIG. 4 shows a block diagram that indicates a configuration of an exposure control unit 32 shown in FIG. 3. As shown in FIG. 4, for example, the exposure control unit 32 includes a processor 41 that performs control and a signal process as mentioned, and an edge detection flag 42.

The edge detection flag 42 indicates an edge detection status of the secondary-scanning-directional reference signal VSYNCref. Here, the secondary-scanning-directional reference signal VSYNCref is an interruption signal, an edge of this signal VSYNCref is sensed, and upon sensing the edge, a value of the edge detection flag 42 is changed from Low to High. The edge detection flag 42 is reset by the primary-scanning-directional reference signal (BD signal). Further, the edge detection flag 42 is also reset by an opposite edge (here, falling edge) of the secondary-scanning-directional reference signal VSYNCref. Here, in this resetting, a value of the edge detection flag 42 is set to be Low by the BD signal (pulse).

The processor 41 refers to the edge detection flag 42 and thereby detects the aforementioned edge or the additional edge. The processor 41 operates with a clock of a predetermined cycle (i.e. the aforementioned cycle TD), and therefore, in the edge detection by the processor 41, a delay occurs due to this clock cycle.

Further, the exposure control unit 32 may adjust an image position in the secondary scanning direction correspondingly to the number of detected edges of the secondary-scanning-directional reference signal VSYNCref within one cycle of the primary-scanning-directional reference signal (BD signal). In such a case, if only one of two edges (the aforementioned edge and the additional edge) is detected, detection of an edge of the secondary-scanning-directional synchronization signal VSYNC is delayed for one cycle of the BD signal (i.e. for time corresponding to one line), and therefore, a position of an image to be depicted is moved by one line in the secondary scanning direction.

Further, the image generating unit 33 determines a front end of a page image to be printed on the basis of the secondary-scanning-directional synchronization signal VSYNC, generates line images in the page image to be printed line by line, and outputs the line images as image signals to the exposure control unit 32 in turn.

The following part explains a behavior of the aforementioned image forming apparatus.

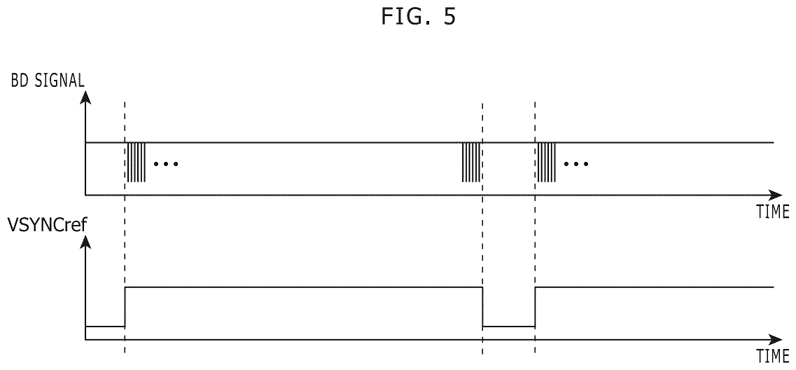

FIG. 5 shows a diagram that indicates an example of a secondary-scanning-directional reference signal VSYNCref and a primary-scanning-directional reference signal (BD signal).

For example, as shown in FIG. 5, the driving control unit 31 generates the secondary-scanning-directional reference signal VSYNCref as a rectangular wave of a predetermined cycle, and outputs this signal VSYNCref to the exposure control unit 32. Further, the exposure device 2 emits a light beam from the light source 21 correspondingly to an image signal, and rotates the polygon mirror 23 and thereby scans a spot position of the light beam on the photoconductor drum 1. Furthermore, while the spot position passes through the BD sensor 24, the exposure device 2 causes the light source 21 to emit the light beam. Consequently, as shown in FIG. 5, for example, the pulse-shaped BD signal is generated correspondingly to every scanning in the primary scanning direction.

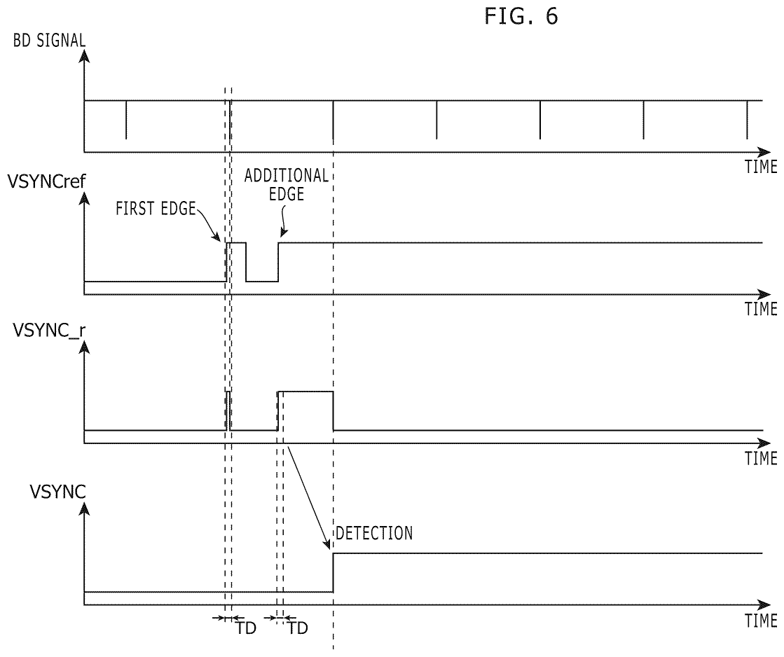

FIG. 6 shows a timing chart that explains behaviors of a driving control unit 31 and the exposure control unit 32. FIG. 6 shows a diagram in which a rising edge part of the secondary-scanning-directional reference signal VSYNCref is enlarged; and although the additional edge is not shown in FIG. 5, the secondary-scanning-directional reference signal VSYNCref actually has an additional edge in addition to a first edge as shown in FIG. 6.

When the secondary-scanning-directional reference signal VSYNCref as mentioned is inputted to the edge detection flag 42, an output value VSYNC_r of the edge detection flag 42 changes to a high level (High), and when the BD signal is detected, an output value VSYNC_r of the the edge detection flag 42 returns to a low level (Low). Further, the processor 41 repeatedly watches the output value VSYNC_r of the the edge detection flag 42 with an interval of the predetermined cycle TD, and if the output value VSYNC_r is the high level (High), then the processor 41 determines that an edge is detected.

Here, if time from a first edge of the secondary-scanning-directional reference signal VSYNCref to the BD signal is short and shorter than the aforementioned predetermined cycle TD, the edge detection flag 42 is reset by the BD signal, and therefore, the first edge may not be detected by the processor 41, as shown in FIG. 6, for example. Even in this case, the additional edge is sufficiently apart from the BD signal, and therefore, the additional edge is detected by the processor 41. Consequently, in this case, the processor 41 generates the secondary-scanning-directional synchronization signal VSYNC in synchronization with the first BD signal after the detection of the additional edge (Pattern #1).

Otherwise, if two edges (i.e. the first edge and the additional edge) are detected within one cycle of the BD signal, then the processor 41 generates the secondary-scanning-directional synchronization signal VSYNC in synchronization with the first BD signal after the detection of the two edges (Pattern #2).

Meanwhile, if the BD signal is detected in between the first edge and the additional edge, then the processor 41 generates the secondary-scanning-directional synchronization signal VSYNC in synchronization with the first BD signal after the detection of the front-end edge (i.e. the first edge), and ignores the detection of the additional edge (i.e. the second edge) (Pattern #3). In this case, the additional edge is detected in a cycle of the BD signal next to the cycle that the first edge is detected, and therefore, if two edges are detected in both of two continuous cycles of the BD signal, then the second edge (the additional edge) is ignored.

Here, if the exposure control unit 32 adjusts an image position in the secondary scanning direction correspondingly to the number of detected edges of the secondary-scanning-directional reference signal VSYNCref within one cycle of the primary-scanning-directional reference signal (BD signal), then in Pattern #1, the image position is adjusted by one line in the secondary scanning direction as mentioned because the secondary-scanning-directional synchronization signal VSYNC is generated with a delay of one cycle of the BD signal from the BD signal immediately after the first edge, but in Pattern #2, this adjustment is not performed because the secondary-scanning-directional synchronization signal VSYNC is generated at the first BD signal after the first edge. In addition, in Pattern #3, this adjustment is excluded, and the secondary-scanning-directional synchronization signal VSYNC is generated at the first BD signal after the first edge; and consequently, this adjustment is not performed as well as in Pattern #2.

In the aforementioned manner, the exposure control unit 32 generates the secondary-scanning-directional synchronization signal VSYNC and provides this signal VSYNC to the image generating unit 33 and provides the primary-scanning-directional synchronization signal HSYNC based on the BD signal to the image generating unit 33. In addition, the image generating unit 33 outputs image signals of line images in turn to the exposure control unit 32 in synchronization with the synchronization signals VSYNC and HSYNC.

The exposure control unit 32 provides the image signals of the line images to the exposure device 2 in synchronization with the BD signal or the primary-scanning-directional synchronization signal HSYNC, and the exposure device 2 causes the light source 21 to emit a light beam correspondingly to the image lines and thereby forms electrostatic latent images corresponding to the image signals line by line on the photoconductor drum 1. Subsequently, the development device 3 attaches toner to the electrostatic latent images and thereby forms a toner image. This toner image is transferred onto a print sheet, and fixed by the fuser 7.

As mentioned, in the aforementioned embodiment, the driving control unit 31 generates the secondary-scanning-directional reference signal VSYNCref. The exposure control unit 32 generates the secondary-scanning-directional synchronization signal VSYNC in synchronization with the primary-scanning-directional reference signal (i.e. BD signal) correspondingly to an edge of the secondary-scanning-directional reference signal VSYNCref, and controls the exposure device 2 and thereby causes the exposure device 2 to form an electrostatic latent image corresponding to an image signal in synchronization with the secondary-scanning-directional synchronization signal VSYNC. Further, the driving control unit 31 generates the secondary-scanning-directional reference signal VSYNCref with a waveform that includes at least one additional edge within a predetermined period from the aforementioned edge.

Consequently, even though the exposure control unit 32 and the driving control unit 31 that generates the secondary-scanning-directional reference signal VSYNCref operate asynchronously with each other, the secondary-scanning-directional synchronization signal VSYNC is properly generated.

It should be understood that various changes and modifications to the embodiments described herein will be apparent to those skilled in the art. Such changes and modifications may be made without departing from the spirit and scope of the present subject matter and without diminishing its intended advantages. It is therefore intended that such changes and modifications be covered by the appended claims.

For example, in the aforementioned embodiment, the image forming apparatus is a monochrome image forming apparatus, but the aforementioned image forming apparatus may be a color image forming apparatus. In case of a color image forming apparatus, for each of plural toner colors (e.g. Cyan, Magenta, Yellow and Black), the aforementioned print engine (the photoconductor drum, the exposure device, the development device and the like) is installed. Further, in the aforementioned embodiment, the image forming apparatus is a direct-transfer image forming apparatus, but the aforementioned image forming apparatus may be an indirect-transfer image forming apparatus. In case of an indirect-transfer image forming apparatus, the toner image on the photoconductor drum is primary-transferred onto an intermediate transfer body, and afterward, the toner image is secondary-transferred from the intermediate transfer body to a print sheet.

Furthermore, in the aforementioned embodiment, the driving control unit 31 generates the secondary-scanning-directional reference signal VSYNCref with a waveform that includes only one additional edge within the predetermined period from the edge, but may generate the secondary-scanning-directional reference signal VSYNCref with a waveform that includes plural additional edges within the predetermined period from the edge.

What is claimed is:

1. An image forming apparatus, comprising:
an exposure device configured to expose a photoconductor drum with light while scanning the light and thereby form an electrostatic latent image;
a driving control unit configured to generate a secondary-scanning-directional reference signal; and
an exposure control unit configured to generate a secondary-scanning-directional synchronization signal in synchronization with a primary-scanning-directional reference signal correspondingly to an edge of the secondary-scanning-directional reference signal, and control the exposure device and thereby cause the exposure device to form an electrostatic latent image corresponding to an image signal in synchronization with the secondary-scanning-directional synchronization signal;
wherein the driving control unit generates the secondary-scanning-directional reference signal with a waveform that includes at least one additional edge within a predetermined period from the edge.

2. The image forming apparatus according to claim 1, wherein the exposure control unit comprises an edge detection flag that indicates an edge detection status of the secondary-scanning-directional reference signal, and detects the edge or the additional edge by referring to the edge detection flag; and
the edge detection flag is reset by the primary-scanning-directional reference signal.

3. The image forming apparatus according to claim 1, wherein the driving control unit generates the secondary-scanning-directional reference signal with a waveform that includes plural additional edges within a predetermined time from the edge.

4. The image forming apparatus according to claim 1, wherein the exposure control unit adjusts an image position in a secondary scanning direction correspondingly to a number of detected edges of the secondary-scanning-directional reference signal within one cycle of the primary-scanning-directional reference signal.

5. The image forming apparatus according to claim 1, wherein the predetermined period is either equal to or less than a half of a cycle of the primary-scanning-directional reference signal.
